(19) United States
(12) Patent Application Publication
(10) Pub. No.: US 2007/0298992 A1
(43) Pub. Date: Dec. 27, 2007

(54) Wheel and tire cleaner composition

(76) Inventors: Hida Hasinovic, Lexington, KY (US); Michael A. Dituro, Huntington, WY (US)

Correspondence Address: CARRITHERS LAW OFFICE, PLLC;One Paragon Centre, Suite 140, 6060 Dutchman's Lane, Louisville, KY, 40205, US

(21) Appl. No.: 11/492,699

(22) Filed: Jul. 25, 2006

Related U.S. Application Data
(60) Provisional application No. 60/815,325, filed on Jun. 21, 2006.

(51) Int. Cl. C11D 3/37

(52) U.S. Cl. 510/189

(57) ABSTRACT

An aqueous wheel cleaning solution for removing the dirt form the surface of aluminum, chrome, stainless steel, painted steel, painted aluminum, clear coated aluminum, rubber, and plastic wheels and tires without scrubbing by applying the cleaning solution to the wheel and/or tire then rinsing the wheel and/or tire with water.

### BACKGROUND OF THE INVENTION

1. Technical Field

This invention relates to an automotive wheel and/or tire cleaning composition for removing the dirt normally found on wheels and/or tires by spraying on and hosing off with water without scrubbing the wheel and/or tire surface.

2. Description of the Prior Art

Since an automobile is a significant personal investment, many people like to keep their automobiles clean and shiny with a minimum amount of effort, to help maintain the value of their investment. The wheels are part of the automobile that requires regular washing and cleaning to maintain the best appearance. There are various designs of wheels and some of those designs have areas that are hard to reach during the cleaning process. In order to help speed up the automobile cleaning process, there is a need for a wheel cleaner that can clean the wheel by spraying on the wheel cleaner, and then rinse off with water, resulting in a clean wheel without actually touching the wheel.

This invention relates to an automotive wheel cleaning composition for removing the dirt normally found on wheels by spraying on and hosing off with water without scrubbing the wheel surface. Since the wheel is mounted on an automobile and encounters a variety of environmental conditions, the dirt that accumulates on the wheels, is a combination of road soil and brake dust. Road soil is a complicated composition that can vary from location to location. Road soil can be divided into organic, which includes mineral oil, vegetable oil, animal fat, etc. and inorganic, which includes dust, dirt and other minerals. Brake dust is an accumulation of very fine participles of carbon black, graphite, metal, etc. that is the residue from the brake pad wearing on the brake disk. The basic composition of brake pads is polymer resins, inorganic fillers, metal particles, etc. Brake pad compositions are guarded secrets by manufacturers and vary by type of resin, fillers, metals and ratios depending on the intended service. Because of the complexity of road soil and brake dust, the material to be cleaned from each vehicle wheel varies every time it is cleaned. Another factor that needs to be considered for cleaning wheels is the material of construction of the wheel. This will affect the bonding force between the dirt and the wheel, which impacts the wheel cleaning performance. In general, the bond between the dirt and the wheel surface is not permanent and the basic type of affinity is Van de Waal force, hydrogen bonding, static electricity, etc.

There are varieties of wheel cleaners on the market, which are either acid or alkaline formulations. However, these products still have cleaning deficiency issues when they are sprayed on and hosed off. The concept of traditional cleaning detergent is to use lipophilic chain of surfactants, ionic and/or non-ionic, to adhere and penetrate the soil layer then detach soil from the wheel surface. In these typical cleaning detergent formulations, builders are used to help surfactants remove dirt and enhance surfactant performance on soil removal. Chelating agents such as ethylenediaminetetraacetic acid (“EDTA”) are used to complex with metal ions to improve cleaning efficiency. However, the cleaning power is still not strong enough to remove all the dirt when these cleaners are sprayed on and hosed off.

### SUMMARY OF THE INVENTION

The cleaning composition of the instant invention is formulated specifically for wheels which are fabricated from materials which may be susceptible to damage from corrosive products; however, all of the compositions set forth in the instant application cleans tires as well.

The present invention provides an aqueous wheel and tire cleaning solution for removing the dirt form the surface of aluminum, chrome, stainless steel, painted steel, painted aluminum, clear coated aluminum and plastic wheels, and/or rubber tires without scrubbing by applying the cleaning solution to the wheel then rinsing the wheel with water. Moreover, the solution may be used on hubcaps or other vehicle exterior parts such as chrome grills, painted fiberglass, rubber, and painted elastomer and plastic bumpers as well. The composition of the instant invention dramatically improves wheel cleaning power without pitting, etching, or hazing the surface of the wheel. After application and removal in a reasonable time period in accordance with the directions on the container.

A preferred wheel and tire composition comprises the following ingredients whereby the percent by weight is based on the total weight of the composition: demineralized water in an amount of 73 percent by weight, a chelating agent such as ethylenediaminetetraacetic acid (VERSENE 100) at 4 percent by weight, a sodium metasilicate pentahydrate (Scouring/Corrosion Inhibiting Agent) at 3 percent by weight, an alcohol ethoxylate such as ALFONIC 810-4.5 at 7 percent by weight, a coupling agent such as SXS-40 at 5 percent by weight, a hydrotrope such as BIOTERGE PAS-8S at 7 percent by weight, a polymer such as VERSA TL-3 at 1 percent by weight, a scouring and/or corrosion inhibiting agent such as a sodium metasilicate pentahydrate at 3 percent by weight, and water.

More particularly, a preferred wheel and tire composition consist essentially of the following ingredients whereby the percent by weight is based on the total weight of the composition: demineralized water in an amount of 73 percent by weight, a chelating agent such as ethylenediaminetetraacetic acid (VERSENE 100) at 4 percent by weight, a sodium metasilicate pentahydrate (Scouring/Corrosion Inhibiting Agent) at 3 percent by weight, an alcohol ethoxylate such as ALFONIC 810-4.5 at 7 percent by weight, a coupling agent such as SXS-40 at 5 percent by weight, a hydrotrope such as BIOTERGE PAS-8S at 7 percent by weight, a polymer such as VERSA TL-3 at 1 percent by weight, a scouring and/or corrosion inhibiting agent such as a sodium metasilicate pentahydrate at 3 percent by weight, and water.

It is an object of the present invention to provide a cleaning solution which can be used by itself or combined with existing conventional cleaners to remove dirt, brake residue, and road grim from wheel surfaces by application to the wheel by spraying or wiping with a cloth or sponge and simply rinsing the wheel cleaner from the wheel surface with water.

It is an object of the present invention to provide a cleaning solution which is effective without requiring scrubbing.

It is a further object of the present invention to provide a wheel cleaner which is effective and does not leave an insoluble residue.

It is another object of the present invention to provide a wheel cleaning solution which can be used on aluminum, chrome, steel wheels, and painted wheels without damaging the surface.

Other objects, features, and advantages of the invention will be apparent with the following detailed description taken in conjunction with the accompanying drawings showing a preferred embodiment of the invention and appended claims.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a photograph of a set of panels (A) cleaned with the wheel and tire cleaner of the present invention compared to a set of panels (B) with no cleaning, wherein the panels were subjected to dust and tested for dust adherence.

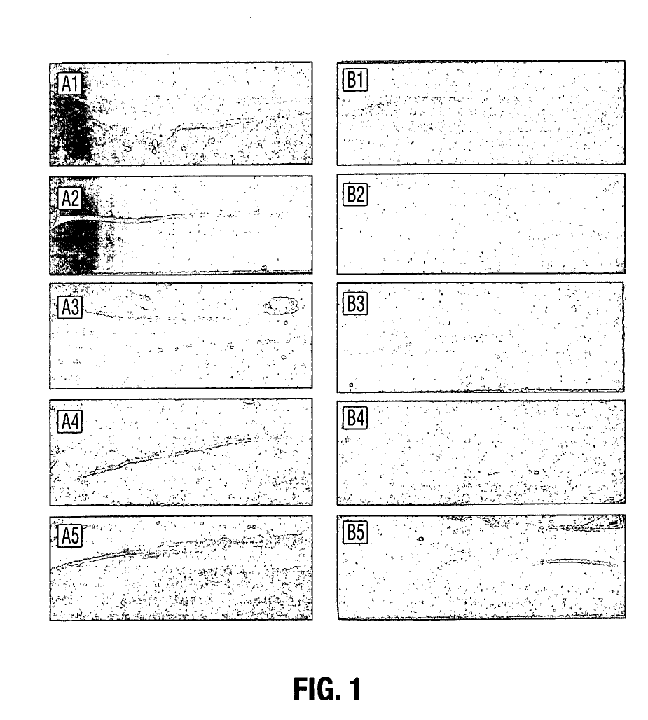

FIG. 2 is a photograph of a wheel and tire being treated with the cleaner as set forth in the instant composition showing the thick blanket of foam which adheres to the portion of the wheel and tire to which it is applied providing optimal residence time to extract dirt from the surface.

### DESCRIPTION OF THE PREFERRED EMBODIMENT

Various formulations were provided for purposes of illustrating the invention. It should be understood that these examples are for illustrative purposes only and are not to be constructed as limiting the scope of the invention in any manner.

### Chelating Agent:

A preferred embodiment of the wheel and tire cleaning composition includes a water softening ion chelating agents such as ethylenediaminetetraacetic acid (“EDTA”) such as sold by the trade name VERSENE 100 (tetrasodium ethylenediaminetetraacetate) by Dow Chemical Company. The chelating agent is sometimes referred to as water conditioners or sequestering agents and are designed to provide effective control of trace metal ions which can hinder the effectiveness of cleaning products for metal ions can reduce the effectiveness of anionic surfactants by forming salts that may be insoluble. The metal ions may also combine with soils to form less dispersible residues that adhere to the surface being cleaned. They promote dissolution of scale, stone, and scum from surfaces.

It may be used to aid in the removal of insoluble deposits of calcium and magnesium soaps and/or as a scouring agent. Moreover a number of salts of EDTA sometimes referred to as edetates are available such as calcium disodium, disodium edetates, tetrasodium, trisodium sodium ferric, dihydrogen ferrous and other disodium salts containing magnesium, cobalt manganese, copper, zinc, and nickel.

The present invention provides the EDTA as an effective, inexpensive scale dissolver that is particularly effective at dissolving sulfate scales such as alkaline earth metal sulfate scales. Furthermore, the dissolver compositions of the invention are relatively easy to use.

The chelating agent should be present in: the composition at a level of from about 0.01 to 20% by weight, and more preferably from about 0.1 to 10% by weight, and more preferably from 1.0 to 8.0% by weight, and more prerferably from 2 to 6% by weight based on the total weight of the composition taken as 100% by weight. One example utilizes 4.0 percent by weight based on the total weight of the composition.

### Corrosion Inhibitor and Scouring Agent:

The cleaning composition according to the invention may further comprise a corrosion inhibitor. A preferred corrosion inhibitor is sodium metasilicate pentahydrate (SMS.5H.sub.2 O), which is an aluminum corrosion inhibitor.

A corrosion inhibiting scouring agent such as sodium metasilicate pentahydrate, sodium metasilicate anhydrous, silicates can be incorporated into the instant composition in effective amounts of up to 10 percent by weight, and more preferably in amounts from 0.1 to 6.0 percent by weight, more preferably from 1 to 4.0 percent by weight based on the total weight of the composition. One preferred example utilizes sodium metasilicate at 3 percent by weight based on the total weight of the composition.

Sodium metasilicate anhydrous and/or other silicates can be added to the composition alone or in combination with other corrosion inhibitors and/or scouring agents. Typically the silicates are added to the formulation in effective amounts which enhance cleaning without pitting the surface of levels of from 0.1 to 10 percent by weight and preferably at levels of from 1 to 5 percent by weight and more preferably in levels from 2 to 4 percent by weight.

The instant invention is directed to the compound sodium metasilicate, and its various hydrates because these are believed to be industrially the most important crystalline soluble, or alkali metal, silicates. Other crystalline alkali metal silicates are known to exist such as sodium disilicate, postassium metasilicate, potassium disilicate, and lithium metasilicate.

The principal uses of alkali metal silicates are as detergent materials. They are used alone or in combination with other material. It is common to mix alkali metal silicates with alkali metal hydroxides, phosphates, polyphosphate, carbonates, alkyl aryl sulfonates, fatty acid soaps, resin soaps, nonionic surface active agents to form useful compounded detergents.

Moreover, it is contemplated that various emulsifiers and dispersing agents can be used such as phosphates, and more particularly such as a tripolyphosphate, a trisodium phosphate, acid phosphates such as mono and disodium phosphates and sodium acid pyrophosphate, and/or a tetrapotassium pyrophosphate, and/or combinations thereof can be used with or in place the sodium metasilicate anhydrous or other silicates in combination with the polymers set forth herein to obtain an alternate embodiment of the present invention. The phosphates and other emulsifiers such as sodium citrate are typically used in effective amounts of up to 10 percent by weight, and more preferably from about 0.1 to 5 percent by weight.

Alcohol ethoxylate:

The instant invention uses nonionic linear alcohol ethoxylates preferably incorporated in amounts ranging from 1 to about 20 percent by weight of the total composition, with a range of from about 1 to 10 percent by weight being more preferred and a range of from 5-10 being most preferred. One preferred embodiment contains 7 percent by weight based on the total weight of the composition.

A preferred linear C.sub.8-10 alkanol is sold under the trademark ALFONIC 810-4.5 (Vista Chemical Co., Houston, Tex.) It is contemplated that the other following linear alcohol ethoxylates can be used as well, including linear C.sub.9-11 alcohol ethoxylate (EO=6), also referred to as polyoxyethylene (6) linear C.sub.9-11 alkanol and sold under the trademark NEODOL 91-6 (Shell Chemical); linear C.sub.11 alcohol ethoxylate (EO=3), also referred to as polyoxyethylene (3) linear C.sub.11 alkanol and sold under the trademark NEODOL 1-3 (Shell Chemical); linear C.sub.11 alcohol ethoxylate (EO=5), also referred to as polyoxyethylene (5) linear C.sub.11 alkanol and sold under the trademark NEODOL 1-5 (Shell Chemical); linear C.sub.11 alcohol ethoxylate (EO=7), also referred to as polyoxyethylene (7) linear C.sub.11 alkanol and sold under the trademark NEODOLI 1-7 (Shell Chemical); linear C.sub.12-13 alcohol ethoxylate (EO=6.5), also referred to as polyoxyethylene (6.5) linear C.sub.12-13 alkanol and sold under the trademark NEODOL 23-6.5 (Shell Chemical); linear C.sub.8-10 alcohol ethoxylate (EO=2), also referred to as polyoxyethylene (2) linear C.sub.8-10 alkanol and sold under the trademark ALFONIC 810-60 (Vista Chemical Co., Houston, Tex.); linear C.sub.10-12 alcohol ethoxylate (EO=6), also referred to as polyoxyethylene (6) linear C.sub.10-12 alkanol and sold under the trademark ALFONIC 1012-60 (Vista Chemical); linear C.sub.8 alcohol ethoxylate (EO=5), also referred to as polyoxyethylene (5) linear C.sub.8 alkanol and sold under the tradename POLY-TERGENT SL-42 (Olin); and linear C.sub.8 alcohol ethoxylate (EO=8), also referred to as polyoxyethylene (8) linear C.sub.8 alkanol and sold under the tradename POLY-TERGENT SL-62 (Olin).

Another of a linear alcohol ethoxylate suitable for the present composition is linear C.sub.9-11 alcohol ethoxylate (EO=8), also referred to as polyoxyethylene (8) linear C.sub.9-11 alkanol. This linear alcohol ethoxylate is available from Shell Chemical Co. of Houston, Tex., under the trademark NEODOL 91-8. It is anticipated that linear alcohol ethoxylates could be used such as C.sub.10 alcohol ethoxylate (EO=4), also referred to as polyoxyethylene (4) linear C.sub.10 alkanol and sold under the tradename RHOADSURF DA-530 (Rhone-Poulenc) and linear C.sub.10 alcohol ethoxylate (EO=6), also referred to as polyoxyethylene (6) linear C.sub.10 alkanol and sold under the tradename RHOADSURF DA-630 (Rhone-Poulenc). It is believed that these alcohol ethoxylates are devoid of alkylphenol compounds and other aromatic alcohols.

One example of a branched alcohol ethoxylate which may be useful for the instant composition is tridecylalcohol ethoxylate (EO=10). This alcohol ethoxylate is also commonly referred to as polyoxyethylene (10) tridecanol, and is available from Rhone-Poulenc, Inc. under the tradename RHOADSURF BC-720.

### Coupling Agent

The cleaning composition can include a coupling agent such as an anionic coupling agent (e.g., aromatic sulfonates such as sodium xylene sulfonate, sodium alkyl napthnlene sulfonates, phosphate esters, alkyl sulfate, etc.), an amphoteric coupling agent (e.g., imidazolines, alkylamphocarboxyglycinates and alkylamphocarboxy-propionates in their mono and dicarboxylo forms, alkyl betaines, amine oxides and the llike. A preferred coupling agent is sodium xylene sulfonate (SXS) or alkyl diphenylether sulfontes. A particularly preferred form of SXS is SXS-40, which is a 40% solution of SXS in water. SXS-40 is sold by Stepan Company under the tradenames STEPANATE SXS.™. and similar products sold by Pilot (PILOT SXS-40) and Witco (WITCONATE SXS liquid, PETRO BA and PETRO AA). The coupling agent minimizes phase separation of the surfactant from the builder during cleaning of the surface.

The coupling agent should be present in: the composition at a level of from about 0.1 to 20% by weight, and more preferably from about 0.1 to 10% by weight, and more preferably from 1.0 to 8.0% by weight, and more prerferably from 3 to 6% by weight based on the total weight of the composition taken as 100% by weight. One example utilizes 5.0 percent by weight based on the total weight of the composition.

### Hydrotrope

An anionic surfactant which is preferred for a hydrotrope surfactant is a aqueous solution of primary alkane sulfonate and more particularly a low foaming biodegradable sodium 1-octane sulfonate. It has excellent coupling properties, is an effective wetting agent, surface tension reducer and hydrotrope. It is stable over a wide pH range, has good compatibility with various conventional detergent builders or additives and stability with respect to hydrogen peroxide. A commercial name for this surfactant is BIOTERGE PAS-8S. It imparts a charge to the composition enabling the composition to better stick to the cationic charged tire surface. Upon application of the wheel cleaner composition to a wheel and tire to be cleaned, the anionic surfactant is important to form a foam blanket providing a longer contact time resulting in improved cleaning when sprayed on the vertical surface of a wheel and tire mounted on a vehicle.

The preferred hydrotrope set forth in the foregoing ingredients can be obtained from commercial sources. For example, the hydrotrope may be obtained from Stepan Chemical Co. as its BIO-TERGE PAS-8S product (CAS #5324-84-5). This anionic surfactant is a mixture of sodium 1-octane sulfonate and sodium 1,2-octane disulfonate. A very similar alkyl sulfonate is also sold by Witco Chemical Co. as “WITCONATE NAS-8,” (CAS #5324-84-5).

The hydrotrope solution should be present in the composition at a level (containing 31% active ingredients) of from about 0.1 to 20% by weight, and more preferably from about 1 to 12% by weight, and more preferably from 2 to 10.0% by weight, and more prerferably from 4 to 5% by weight based on the total weight of the composition taken as 100% by weight. One example utilizes 7.0 percent by weight based on the total weight of the composition.

### Polymer

A commercially avialable sulfonated styrene maleic anhydride material is available from the National Starch and Chemical Corporation as VERSA TL-3.

A commercially available copolymer of sulfonated styrene and maleic anhydride which is used in commercial cooling water corrosion and scale control products, VERSA TL-4, available from National Starch and Chemical Corporation. Sulfonated styrene/maleic anhydride copolymers (and their salts) are known. See for example, U.S. Pat. No. 4,450,261, the entire contents of which are hereby incorporated by reference in the present specification. Multiple grades of sulfonated styrene/maleic anhydride copolymers are commercially available, including those available as Versa TL-3 (weight average molecular weight[equals]20,000), Rs aqueous solution form Versa TL-4 (25% w/w Versa TL-3), and Versa TL-7 (weight average molecular weight[equals] 15,000) from Alco Chemical, a division of National Starch and Chemical Co. (Chattanooga, Tenn.). Generally, the sulfonated styrene/maleic anhydride copolymers suitable for use in the compositions of the present invention will have a molecular weight (weight average) from 5000 to 100,000. The ratio of styrene sulfonic acid to maleic anhydride in the copolymers suitable for use in the compositions of the present invention will range from 2:1-4:1, and will preferably be about 3:1.

The compositions of the present invention comprise a sulfonated styrene/maleic anhydride copolymer in an amount effective to enhance foaming and repellency of dirt. The amount of copolymer will range from 0.01 to 10%, preferably 0.1 to 5%, and more preferably from 0.5 to 2 percent by weight based on the total weight of the composition. One preferred embodiment comprises about 1 percent by weight VERSA TL-3 based on the total weight of the composition.

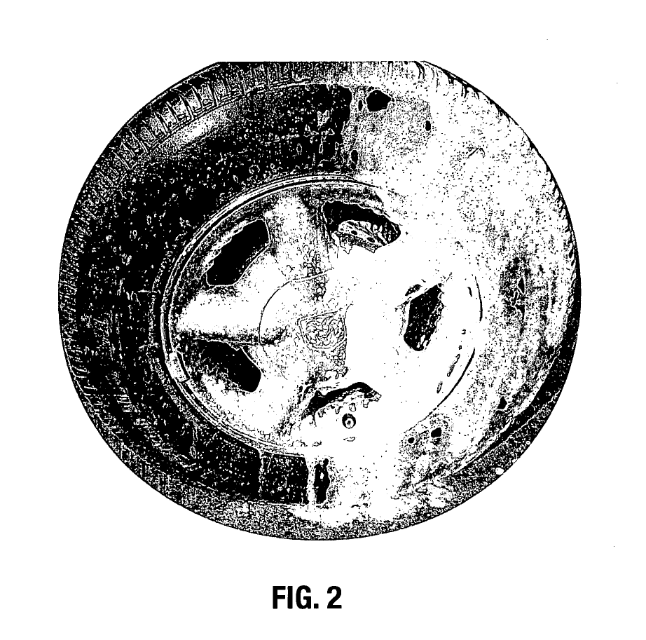

The sulfonated styrene/maleic anhydride copolymer, (VERSA TL-3), used in the present invention aids in the formatuion of a thick and stable foam that sticks to the surface providng better contact with an increased residence time as compared to conventional foaming products to enable the cleaning components of the formulation extract dirt from the tire surface with more efficiency. As shown in FIG. 2, the test tire shows a thick blanket of foam which typically lasts from up to five minutes on a tire (rubber) and wheel surface (chrome, steel, plastic, or aluminum) subjected to ordinary road dirt and preferably from 2 to 5 minutes. Most tire and wheel foaming compositions break down almost immediately upon application to the surface to be cleaned.

Moreover, the sulfonated styrene/maleic anhydride copolymer, for instance (VERSA TL-3), is important in leaving a film which repels dirt and is dust resistant.

### Water

Typically the water used in the formulation is soft or demineralized water in an amount ranging from of 50 to 90 percent by weight or more based on the total weight of the composition, and more preferably from 60 to 80 percent by weight and more preferably from 65 to 75 percent by weight based on the toal weight of the composition. One preferred embodiment comprises 73 percent by weight of demineralized water based on the total weight of the composition.

### Other Optional Additives

Suitable detergents capable of dissolving and emulsifying organic soils include, but are not limited to anionic synthetic detergents such as alkyl sulfates such as sodium lauryl sulfate, alkyl ether sulfates, and linear alkyl benzene sulfonates. The amount of detergents used in the composition is not critical so long as it remains soluble in an aqueous solution and is capable of dissolving and emulsifying organic soils. The amount of detergent used typically depends on the amount used. For example, nonionic detergents can be used in amounts of up to 40 percent by weight. Anionic synthetic detergents can be used in amounts up to 30 percent by weight.

An effective amount of an alkaline cleaner capable of dissolving and emulsifying organic soils selected from the group consisting of a detergent, a water soluble organic solvent, a glycol ether, a sodium hydroxide solution, a potassium hydroxide solution, an alkaline silicate, an alkaline phosphate, and combinations thereof can also be added to the instant composition.

Organic solvents which can be used in with the polymers of the instant invention include, but are not limited to glycols such as ethylene and propylene glycol, glycol ethers, hydrocarbons, alcohols, n-methylpyrrolidone, ketones, lactones, and terpenes such as d-limonene. The organic solvents can be used in amounts of up to 50% by weight.

Dispersing agents and emulsifiers such as a trisodium phosphate, a tetrapotassium pyrophosphate, sodium tripolyphosphate, sodium citrate, and acid phosphates such as mono and disodium phosphate and sodium acid pyrophosphate compounds can be used in effective amounts of up to 10 percent by weight, and more preferably in amounts from 0.01 to 5.0 percent and more preferably from 0.1 to 3.0 percent.

The following examples utilize the polymers of the present invention together with conventional cleaning constituents.

### EXAMPLE 1

### Wheel and Tire Cleaning Compositions

| Component | % By Weight |
|---|---|
| DI Water | 73 |
| VERSENE 100 (EDTA Chelating Agent) | 4 |
| Sodium Metasilicate Pentahydrate (Cleaning/ | 3 |
| Scouring/Corrosion Inhibiting Agent) | |
| ALFONIC 810-4.5 (alcohol ethoxylate) | 7 |
| SXS-40 (Coupling Agent) | 5 |
| BIOTERGE PAS-8S (hydrotrope) | 7 |
| VERSA TL-3 (Polymer) | 1 |

The composition set forth in Example 1 is a clear liquid having a pH of from about 13-14, weight percent solids of about 16 to 17 percent, specific gravity of from about 1.050 to 1.060 and 16.8 to about 17.2 brix. The composition set forth in Example 1 resulted in a clean wheel with no residue.

### Preparation of Wheel Cleaning Compositions

Wheel cleaning compositions were prepared in a routine manner, generally using the following general procedure. De-ionized water was added to a glass beaker with a magnetic stirrer. With the mixer running, each ingredient was added into the mixture. While order of addition of ingredient is not believed to be critical, the surfactants were added last. Each ingredient was allowed to become completely dispersed prior to the addition of the next ingredient. After the addition of the final ingredient, the mixture is allowed to stir for a period of up to 15 minutes and preferably at least 5 minutes to ensure a homogeneous mixture.

### Method of Application

A method for cleaning an oil/grease/brake carbon stained wheel and tire surface comprising the steps of applying a cleaning composition to the stained surface, the cleaning composition comprising a chelating agent scouring agent alcohol ehthoxylate, hydrotrope polymer and coupling agent, whereby the coupling agent minimizes phase separation of the surfactant and anionic detergent during cleaning of the surface; allowing the composition to set on the surface; and rinsing the surface with water. The rinsing is carried out after the cleaning composition is allowed to set for at least 3-5 minutes.

It should be noted that for test purposes the solution was allowed to remain on the wheel for one minute; however, this time period is not critical, for depending upon the condition of the wheel to be cleaned, the solution can be effective in a matter of seconds and be rinsed off immediately after application. Although the solution could be allowed to remain on the wheel for several minutes, for instance up to five minutes, typically within at least thirty seconds the cleaning composition has dissolved the dirt and is ready for rinsing.

### Cleaning Performance of Various Wheel Cleaning Compositions

Cleaning effectiveness was evaluated by the following method. Each formulation was applied to a dirty wheel using a trigger sprayer and saturating the entire surface. The compositions were allowed to soak for one (1) minute at room temperature without any scrubbing. The wheel was then rinsed with water at normal household water pressure. After rinsing, the wheel surfaces were visually evaluated for cleanness of the wheel. Each cleaning composition was rated on a scale of 1 (no dirt removal) to 5 (complete dirt removal).

### Dust Repellency Test of Wheel Cleaning Compositions

A dust repellency test was designed to determine which tires treated with difference compositions repelled dust best.

The data and procedure for conducting the test was as follows where dust adherence (md) is defined by md=m2−m1:

| Panel | m1 (g) | m2 (g) | md (g) | md (mg) |
|---|---|---|---|---|
| A1 | 49.2432 | 49.245 | 0.0018 | 1.8 |
| A2 | 48.9386 | 48.9401 | 0.0015 | 1.5 |
| A3 | 48.5767 | 48.5779 | 0.0012 | 1.2 |
| A4 | 48.5672 | 48.5712 | 0.004 | 4 |
| A5 | 49.1273 | 49.1285 | 0.0012 | 1.2 |
| Bbar | | | 0.00194 | 1.94 |
| B1 | 49.0729 | 49.0736 | 0.0007 | 0.7 |
| B2 | 48.1709 | 48.174 | 0.0031 | 3.1 |
| B3 | 48.6753 | 48.6758 | 0.0005 | 0.5 |
| B4 | 49.0503 | 49.0526 | 0.0023 | 2.3 |
| B5 | 49.1512 | 49.1523 | 0.0011 | 1.1 |
| Cbar | | | 0.00154 | 1.54 |

Notes:
Formula A applied to panel as set forth in Example 1.
Formula B = No cleaner applied to panel.

### Panels are 3″×6″ aluminum panels with mirror finish.

### Panels were not cleaned after previous test.

### Procedure:

### 1 Panels were placed at ˜60 deg. angle (long side on vertical).

### 2 Two squirts of cleaner were sprayed at the top of each panel.

### 3 Cleaner was allowed to work for 30 s.

### 4 Panels were rinsed under cold water (fully open valve) for 3 sec.

### 5 Panels placed at ˜60 deg angle to dry.

### 6 Panels were allowed to dry for 24 hrs.

### 7 Panels and beaker of dust were placed in desiccator for 30 min.

### 8 Initial weight (m1) of each panel was measured.

9 5 g+/−0.05 g of dust was sprinkled over panel to fully cover entire area.

### 10 Panel was turned vertical (long side on horizontal).

### 11 Panel was raised 1 inch above table surface and dropped 3 times.

### 12 Final weight (m2) of each panel was measured.

### 13 Dust adherence (md) is defined by md=m2−m1.

### 14 Steps 113 were repeated for other cleaner.

### 15 Steps 4-13 were repeated for control panels.

### Results

The cleaner surface of Panel A treated with the tire and wheel cleaning composition as set fourth in Example 1 attracted slightly more dust because the surface of the panel was clean. Examination of the panels (a) show a more even distribution of dust forming a film as compared to the untreated panels (b) showing accumulations of dust.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

We claim:

1. A wheel and tire cleaning composition in an effective amount to clean a wheel and tire comprising:
a chelating agent;
a scouring agent;
an alcohol ethoxylate;
a coupling agent a hydrotrope;
a polymer; and
water.

2. A wheel and tire cleaning composition for cleaning a wheel and tire comprising:
a chelating agent in an amount from 0.1 to 10 percent by weight based on the total weight of the composition;
a scouring agent in an amount of from 0.1 to 10 percent by weight based on the total weight of the composition;
an alcohol ethoxylate in an amount of from 1 to 10 percent by weight based on the total weight of the composition;
a coupling agent in an amount of from 0.1-10 percent by weight based on the total weight of the composition;
a hydrotrope in an amount of from 1-12 percent by weight based on the total weight of the composition;
a polymer in an amount of from 0.01 to 10 percent by weight based on the total weight of the composition; and the remainder
water.

3. The composition of claim 2 wherein said chelating agent is a ethylenediaminetetraacetic acid.

4. The composition of claim 2, wherein said scouring agent comprises sodium metasilicate pentahydrate.

5. The composition of claim 2 wherein said alcohol ethoxylate comprises a polyoxyethylene.

6. The composition of claim 2, wherein said coupling agent comprises a sodium xylene sulfonate.

7. The composition of claim 2, wherein said hydrotrope comprises sodium 1-octane sulfonate.

8. The composition of claim 2, wherein said polymer comprises a sulfonated styrene maleic anhydride material.
